(19) United States
(12) Patent Application Publication
(10) Pub. No.: US 2009/0228273 A1
(43) Pub. Date: Sep. 10, 2009

(54) HANDWRITING-BASED USER INTERFACE FOR CORRECTION OF SPEECH RECOGNITION ERRORS

(75) Inventors: Lijuan Wang, Beijing (CN); Frank Kao-Ping Soong, Beijing (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/042,344

(22) Filed: Mar. 5, 2008

(51) Int. Cl. G10L 15/26; G06F 3/033; G06K 9/00

(52) U.S. Cl. 704/235; 345/173; 704/E15.043; 382/189

(57) ABSTRACT

A speech recognition result is displayed for review by a user. If it is incorrect, the user provides pen-based editing marks. An error type and location (within the speech recognition result) are identified based on the pen-based editing marks. An alternative result template is generated, and an N-best alternative list is also generated by applying the template to intermediate recognition results from an automatic speech recognizer. The N-best alternative list is output for use in correcting the speech recognition results.

### BACKGROUND

The use of speech recognition technology is currently gaining popularity. One reason is that speech is one of the most convenient human-machine communication interfaces for running computer applications. Automatic speech recognition technology is one of the fundamental components for facilitating human-machine communication, and therefore this technology has made substantial progress in the past several decades.

However, in real world applications, speech recognition technology has not gained as much penetration as was first believed. One reason for this is that it is still difficult to maintain consistent, robust, speech recognition performance across different operating conditions. For example, it is difficult to maintain accurate speech recognition in applications that have variable background noises, different speakers and speaking styles, dialectical accents, out-of-vocabulary words, etc.

Due to the difficulty in maintaining accurate speech recognition performance, speech recognition error correction is also an important part of the automatic speech recognition technology. Efficient correction of speech recognition errors is still rather difficult in most speech recognition systems.

Many current speech recognition systems rely on a spoken input in order to correct speech recognition errors. In other words, when a user is using a speech recognizer, the speech recognizer outputs a proposed result of the speech recognition function. When the speech recognition result is incorrect, the speech recognition system asks the user to repeat the utterance which was incorrectly recognized. In doing so, many users repeat the utterance in an unnatural way, such as very slowly and distinctly, and not fluently as it would normally be spoken. This, in fact, often makes it more difficult for the speech recognizer to recognize the utterance accurately, and therefore, the next speech recognition result output by the speech recognizer is often erroneous as well. Correcting a speech recognition result with speech thus often results in a very frustrating user experience.

Therefore, in order to correct errors made by an automatic speech recognition system, some other input modes (other than speech) have been tried. Some such modes include using a keyboard, spelling out the words using spoken language, and using pen-based writing of the word. Among these various input modalities, the keyboard is probably the most reliable. However, for small handheld devices, such as personal digital assistants (PDAs) or telephones, which often have a very small keypad, it is difficult to key in words in an efficient manner without going through at least some type of training process.

It is also known that some current handheld devices are provided with a handwriting input option. In other words, using a “pen” or stylus, a user can perform handwriting on a touch-sensitive screen. The handwriting characters entered on the screen are submitted to a handwriting recognition component that attempts to recognize the characters written by the user.

In most prior error correction interfaces, locating the error in a speech recognition result is usually done by having a user select the misrecognized word in the result. However, this does not indicate the type of error, in any way. For instance, by selecting a misrecognized word, it is still not clear whether the recognition result contains an extra word or character, has misspelled a word, has output the wrong sense of a word, or is missing a word, etc.

The discussion above is merely provided for general background information and is not intended to be used as an aid in determining the scope of the claimed subject matter.

### SUMMARY

A speech recognition result is displayed for review by a user. If it is incorrect, the user provides pen-based editing marks, and an error type and location (within the speech recognition result) are identified. An alternative result template is generated and an N-best alternative list is also generated by applying the template to intermediate recognition results from the automatic speech recognizer. The N-best alternative list is output for use in correcting the speech recognition results.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIGS. 1A and 1B (hereinafter FIG. 1) is a block diagram of one illustrative embodiment of a user interface.

FIGS. 2A-2B (hereinafter FIG. 2) show one embodiment of a flow diagram illustrating the operation of the system shown in FIG. 1.

FIGS. 3 and 4 illustrate pen-based inputs identifying types and location of errors in a speech recognition result.

FIG. 5 illustrates one embodiment of a user interface display of an alternative list.

FIG. 6 illustrates one embodiment of a user handwriting input for error correction.

FIG. 7 is a flow diagram illustrating one embodiment of the operation of the system shown in FIG. 1 in generating a template and an alternative list.

FIG. 8 shows a plurality of different, exemplary, templates.

FIG. 9 is a block diagram of one illustrative embodiment of a speech recognizer.

FIG. 10 shows one embodiment of a handheld device.

### DETAILED DESCRIPTION

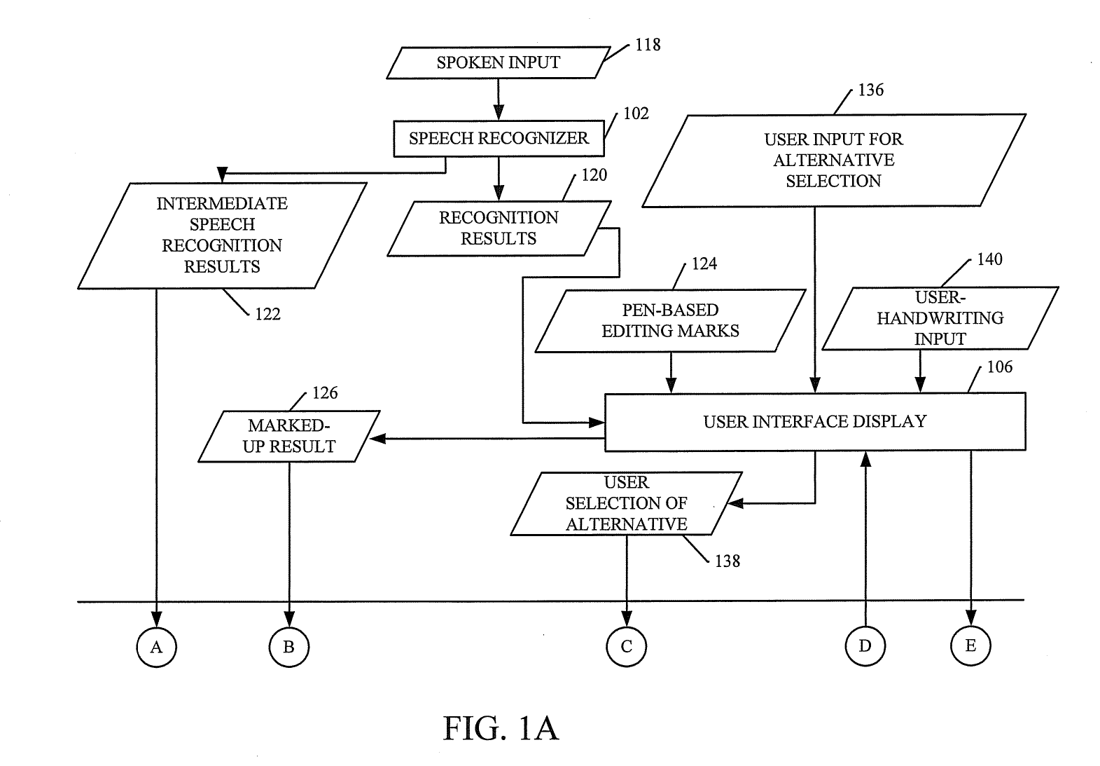

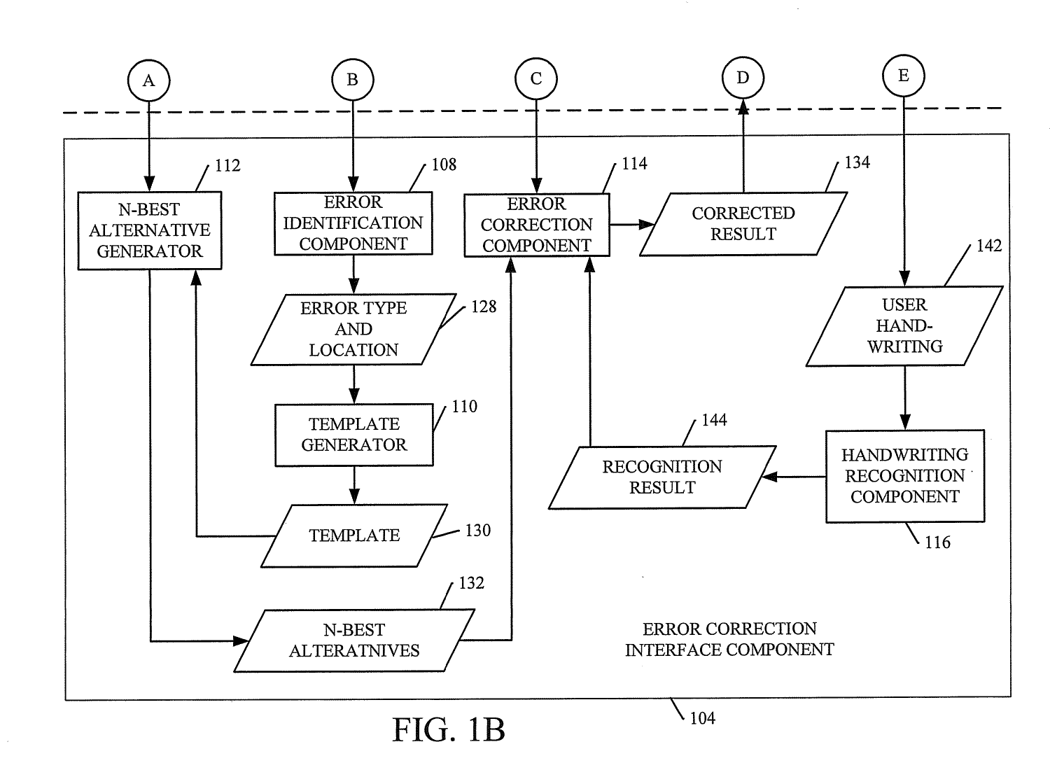

FIG. 1 is a block diagram of a speech recognition system 100 that includes speech recognizer 102 and error correction interface component 104, along with user interface display 106. Error correction interface component 104, itself, includes error identification component 108, template generator 110, N-best alternative generator 112, error correction component 114, and handwriting recognition component 116.

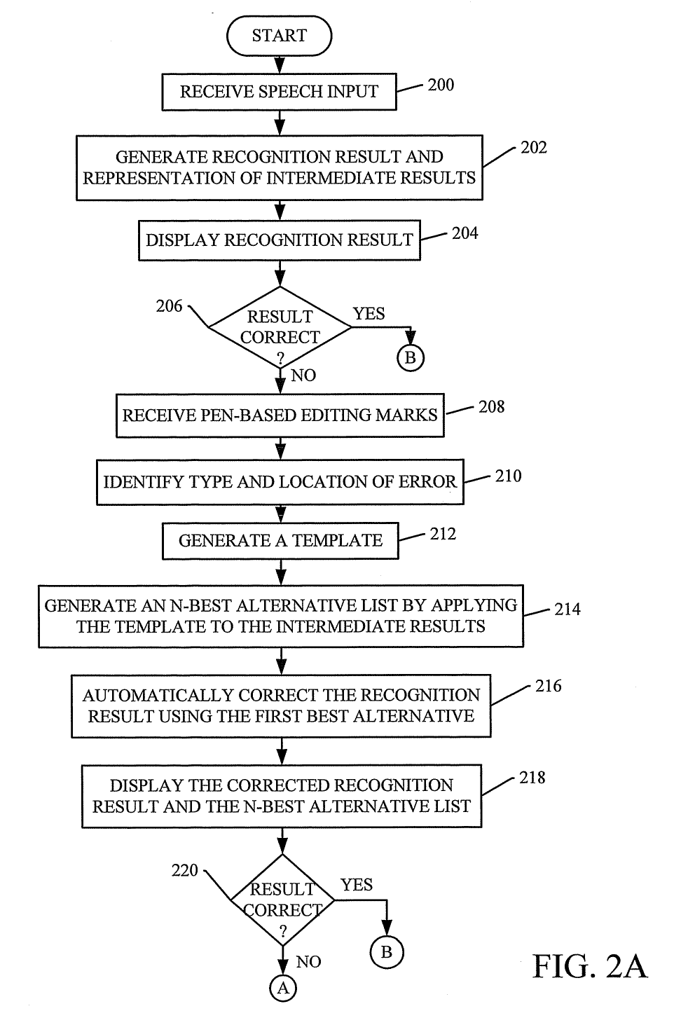

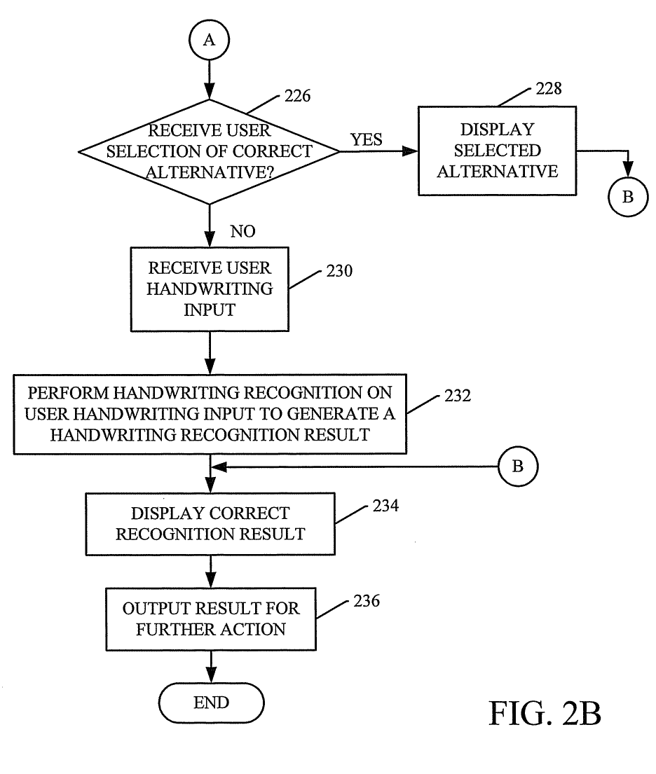

FIGS. 2A and 2B show one illustrative embodiment of a flow diagram that illustrates the operation of speech recognition system 100 shown in FIG. 1. Briefly, by way of overview, speech recognizer 102 recognizes speech input by the user and displays it on display 106. The user can then use error correction interface component 104 to correct the speech recognition result, if necessary.

More specifically, speech recognizer 102 first receives a spoken input 118 from a user. This is indicated by block 200 in FIG. 2A. Speech recognizer 102 then generates a recognition result 120 and displays it on display 106. This is indicated by blocks 202 and 204 in FIG. 2A.

In generating the speech recognition result 120, speech recognizer 102 also generates intermediate recognition results 122. Intermediate recognition results 122 are commonly generated by current speech recognizers as a word graph or confusion network. These are normally not output by a speech recognizer because they cannot normally be read or deciphered easily by a human user. When depicted in graphical form, they normally resemble a highly interconnected graph (or “spider web”) of nodes and links. The graph is a very compact representation of high probability recognition hypotheses (word sequences) generated by the speech recognizer. The speech recognizer only eventually outputs the highest probability recognition hypothesis, but the intermediate results are used to identify that hypothesis.

In any case, once the recognition result 120 is output by speech recognizer 102 and displayed on user interface display 106, it is determined whether the recognition result 120 is correct or whether it needs to be corrected. This is indicated by block 206 in FIG. 2A.

If the user determines that the displayed speech recognition result is incorrect, then the user provides pen-based editing marks 124 through user interface display 106. For instance, system 100 is illustratively deployed on a handheld device, such as palmtop computer, a telephone, a personal digital assistant, or another type of mobile device. User interface display 106 illustratively includes a touch-sensitive area which, when contacted by a user (such as by using a pen or stylus) receives the user input editing marks from the pen or stylus. In the embodiment described herein, the pen-based editing marks not only indicate a position within the displayed recognition result 120 that contains the error, but also indicate a type of error that occurs at that position. Receiving the pen-based editing marks 124 is indicated by block 208 in FIG. 2A.

The marked up speech recognition result 126 is received, through display 106, by error identification component 108. Error identification component 108 then identifies the type and location of the error in the marked up recognition result 126, based on the pen-based editing marks 124 input by the user. Identifying the type and location of the error is indicated by block 210 in FIG. 2A.

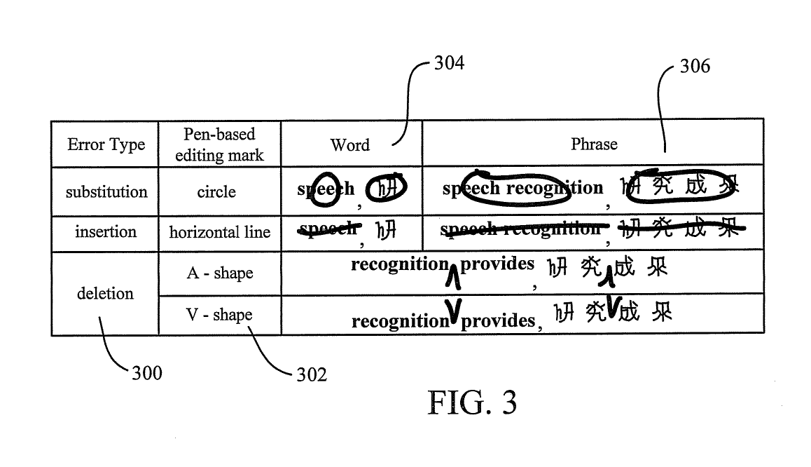

In one embodiment, error identification component 108 includes a handwriting recognition component (which can be the same as handwriting recognition component 116 described below, or a different handwriting recognition component) which is used to process and identify the symbols used by the user in pen-based editing marks 124. While a wide variety of different types of pen-based editing marks can be used to identify error type and error position in the recognition result 120, a number of examples of such symbols are shown in FIG. 3.

FIG. 3 shows a multicolumn table in which the left column 300 identifies the type of error being corrected. The second column 302 describes the pen-based editing mark used to identify the type of error being corrected, and columns 304 and 306 show single word errors and phrase errors, respectively, that are marked with the pen-based editing marks identified in column 302. The error types identified in FIG. 3 are substitution errors, insertion errors and deletion errors.

A substitution error is an error in which a word (or other token) is misrecognized as another word. For instance, where the word “speech” is misrecognized as the word “screech”, this is a substitution error because an erroneous word was substituted for a correct word in the recognition result.

An insertion error is an error in which one or more spurious words or characters (or other tokens) are inserted in the speech recognition result, where no word(s) or character(s) belongs. In other words, where the erroneous recognition result is “speech and recognition”, but where the actual result should be “speech recognition” the word “and” is erroneously inserted in a spot where no word belongs, and is thus an insertion error.

A deletion error is an error in which one or more words or characters (or other tokens) have been erroneously deleted. For instance, where the erroneous speech recognition result is “speech provides” but the actual recognition result should be “speech recognition provides”, the word “recognition” has erroneously been deleted from the speech recognition result.

FIG. 3 shows these three types of errors, and the pen-based editing marks input by the user to identify the error types. It can be seen in FIG. 3 that a circle represents a substitution error. In that case, the user circles a portion of the word (or phrase) which contains the substitution error.

FIG. 3 also shows that a horizontal line indicates an insertion error. In other words, the user simply strikes out (by placing a horizontal line through) the erroneously inserted words or characters to identify the position of the insertion error.

FIG. 3 also shows that a chevron or carrot shape (a v, or inverted v) is used to identify a deletion error. In other words, the user places the appropriate symbol at the place in the speech recognition result where words or characters have been skipped.

It will, of course, be noted that the particular pen-based editing marks used in FIG. 3, and the list of error types used in FIG. 3, are exemplary only. Other error types can also be marked for correction, and the pen-based editing marks used to identify the error type can be different than those shown in FIG. 3. However, both the errors and the pen-based editing marks shown in FIG. 3 are provided for the sake of example.

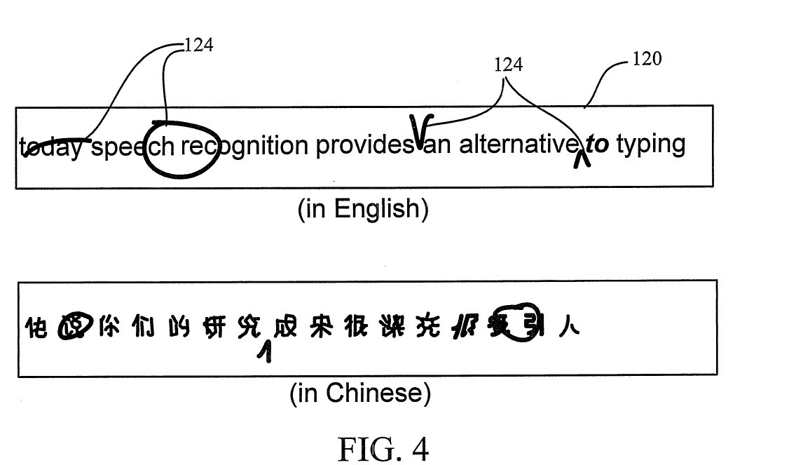

FIG. 4 illustrates a recognition result 120 in which the user has provided a plurality of pen-based editing marks 124 to show a plurality of different errors in the recognition result 120. Therefore, it can be seen that the pen-based editing marks 124 can be used to identify not only a single error type and error position, but the types of multiple different errors, and their respective positions, within a speech recognition result 120.

Error identification component 108 identifies the particular error type and location in the speech recognition result 120 by performing handwriting recognition on the symbols in the pen-based editing marks to determine whether they are circles, v or inverted v shapes, or horizontal lines. Based on this handwriting recognition, component 108 identifies the particular types of errors that have been marked by the user.

Component 108 then correlates the particular position of the pen-based editing marks 124 on the user interface display 106, relative to the words in the speech recognition result 120 displayed on the user interface display 106. Of course, these are both provided together in marked up result 126. Component 108 can thus identify within the speech recognition result, the type of error noted by the user, and the particular position within the speech recognition result that the error occurred.

The particular position may be the word position of the word within the speech recognition result, or it may be a letter position within an individual word, or it may be a location of a phrase. The error position can thus be correlated to a position in the speech signal that spawns the marked result. The error type and location 128 are output by error identification component 108 to template generator 110.

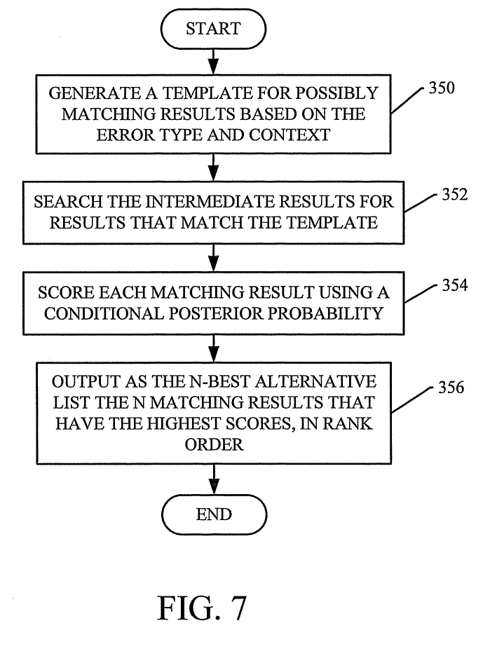

Template generator 110 generates a template 130 that represents word sequences which can be used to correct the error having the identified error type. In other words, the template defines allowable sequences of words that can be used in correcting the error. Template generation is described in greater detail below with respect to FIG. 7. Generating the template is indicated by block 212 in FIG. 2A.

Once template 130 has been generated, it is provided to N-best alternative generator 112. Recall that intermediate speech recognition results 122 have been provided from speech recognizer 102 to N-best alternative generator 112. The intermediate speech recognition results 122 embody a very compact representation of high probability recognition hypotheses generated by speech recognizer 102. N-best alternative generator 112 applies the template 130 provided by template generator 110 against the intermediate speech recognition results 122 to find various word sequences in the intermediate speech recognition results 122 that conform to the template 130.

The intermediate speech recognition results 122 will also, illustratively, have scores associated with them from the various models in speech recognizer 102. For instance, speech recognizer 102 will illustratively include acoustic models and language models, all of which output scores indicating how likely it is that the components (or tokens) of the hypotheses in the intermediate speech recognition results are the correct recognition for the spoken input. Therefore, N-best alternative generator 102 identifies the intermediate speech recognition results 122 that conform to template 130, and ranks them according to a conditional posterior probability, which is also described below with respect to FIG. 7. The score calculated for each alternative recognition result identified by generator 112 is used to rank those results in order of their score. The N-best alternatives 132 comprise the alternative speech recognition results identified in intermediate speech recognition results 122, given template 130, and the scores generated by generator 112, in rank order. Generating the N-best alternative list by applying the template to the intermediate speech recognition results 122 is indicated by block 214 in FIG. 2A.

In one illustrative embodiment, once the N-best alternative list has been generated, error correction component 114 automatically corrects speech recognition result 120 by substituting the first-best alternative from N-best alternative list 132 as the corrected result 134. The corrected result 134 is then displayed on user interface display 106 for confirmation by the user. Automatically correcting the recognition result using the first-best alternative is indicated by block 216 in FIG. 2A (and is optional), and displaying corrected result 134 is indicated by block 218. At the same time, the N-best alternative list 132 is also displayed on user interface display 106 without any user request. Alternatively, list 132 may be displayed after the user has requested it.

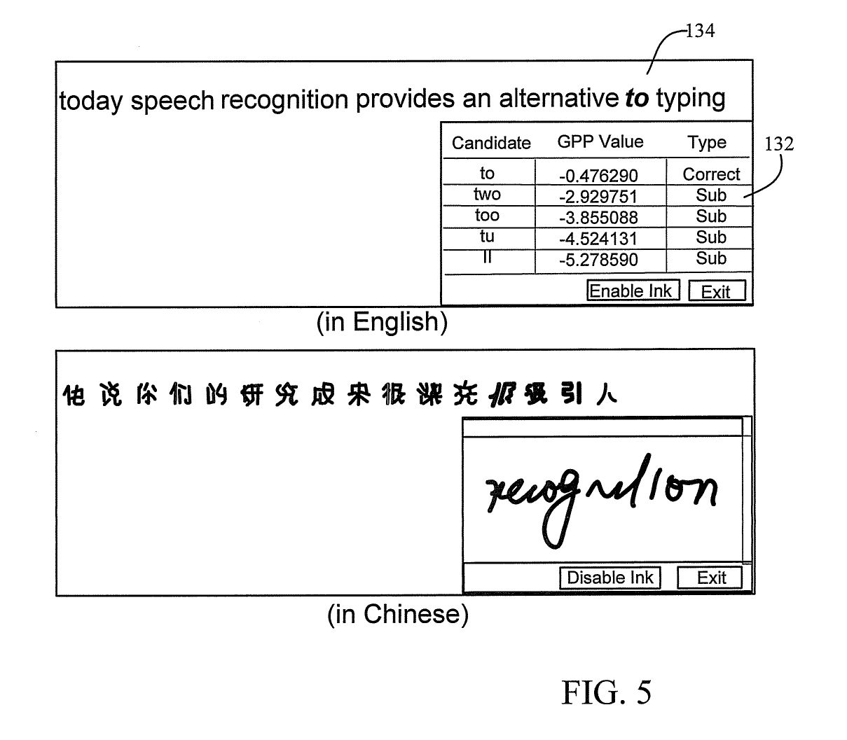

FIG. 5 shows two illustrative user interface displays with the N-best alternative list 132 displayed. The interfaces are shown for both the English and Chinese languages. It can be seen that the user interface has an area that displays the corrected result 134, and an area that displays the N-best alternative list 132. The user interface is also provided with buttons that allow a user to correct result 134 with one of the alternatives in list 132. In order to do so, the user illustratively provides a user input 136 selecting one of the alternatives in list 134 to have the alternative from list 132 replace the particular word or phrase in result 134 that is selected for correction. Error correction component 114 then replaces the text to be corrected in result 134 with the corrected result from the N-best alternative list 132 and displays the newly corrected result on user interface display 106. The user input identifying user selection of one of the alternatives in list 132 is indicated by block 138 in FIG. 1. Receiving the user selection of the correct alternative from list 132 is indicated by block 226 in FIG. 2B, and displaying the corrected result is indicated by block 228.

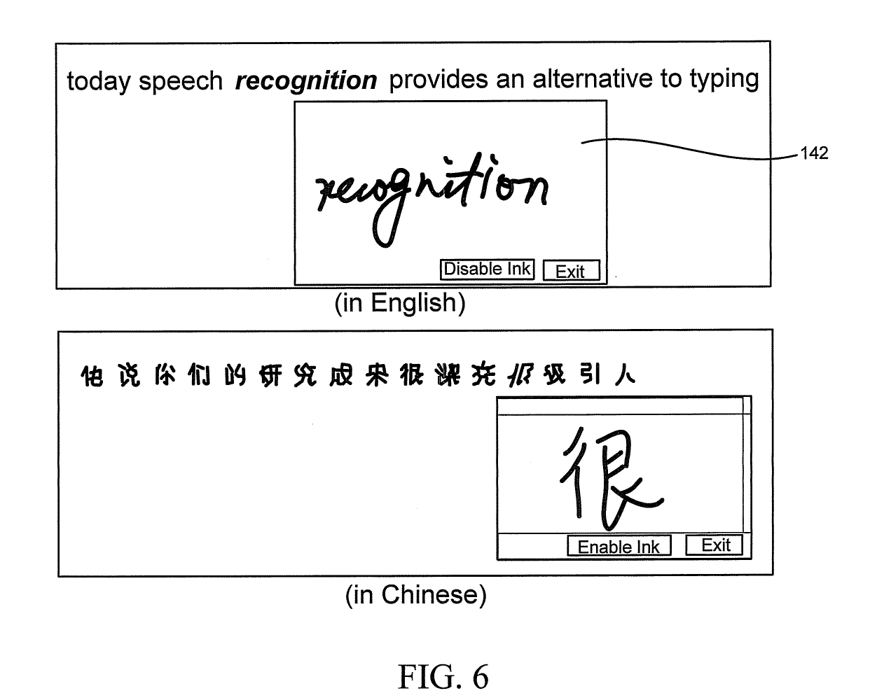

If, at block 226, the user is unable to locate the correct result in the N-best alternative list 132, the user can simply provide a user hand writing input 140. User hand writing input 140 is illustratively a user input in which the user spells out the correct word or phrase that is currently being corrected on user interface display 106. For instance, FIG. 6 shows one embodiment of a user interface in which the system is correcting the word “recognition” which has been marked as being erroneous by the user. The first-best alternative in N-best alternatives list 132 was not the correct recognition result, and the user did not find the correct recognition result in the N-best alternative list 132, once it was displayed. As shown in FIG. 5, the user simply writes the correct word or phrase (or other token such as a Chinese character) on a handwriting recognition area of user interface display 106. This is indicated as user handwriting 142 in FIG. 1 and is shown also on the display screen of the user interface shown in FIG. 6. Receiving the user handwriting input is indicated by block 230 in FIG. 2B.

Once the user handwriting input 142 is received, it is provided to handwriting recognition component 116 which performs handwriting recognition on the characters and symbols provided by input 142. Handwriting recognition component 116 then generates a handwriting recognition result 144 based on the user handwriting input 142. Any of a wide variety of different known handwriting recognition components can be used to perform handwriting recognition. Performing the handwriting recognition is indicated by block 232 in FIG. 2B.

Recognition result 144 is provided to error correction component 114. Error correction component 114 then substitutes for the word or phrase being corrected, the handwriting recognition result 144, and outputs the newly corrected result 134 for display on user interface display 106.

Once the correct recognition result has been obtained (at any of blocks 206, 220, 228, or 232), the correct recognition result is finally displayed on user interface display 106. This is indicated by block 234 in FIG. 2B.

The result can then be output to any of a wide variety of different applications, either for further processing, or to execute some task, such as command and control. Outputting the result for some type of further action or processing is indicated by block 236 in FIG. 2B.

It can be seen from the above description that interface component 104 significantly reduces the handwriting burden on the user in order to make error corrections in the speech recognition result. Automatic correction can be performed first. Also, in order to speed up the process, in one embodiment, a N-best alternative list is generated, from which the user chooses an alternative, if the automatic correction is unsuccessful. A long alternative list 132 can be visually overwhelming, and can slow down the correction process and require more interaction from the user, which may be undesirable. In one embodiment, the N-best alternative list 132 displays the five best alternatives for selection by the user. Of course, any other desired number could be used as well, and five is given for the sake of example only.

FIG. 7 is a flow diagram that illustrates one embodiment, in more detail, of template generation and of generating the N-best alternative list 132. Generalized posterior probability is a probabilistic confidence measure for verifying recognized (or hypothesized) entities at a subword, word or word string level. Generalized posterior probability at a word level assesses the reliability of a focused word by “counting” its weighted reappearances in the intermediate recognition results 122 (such as the word graph) generated by speech recognizer 102. The acoustic and language model likelihoods are weighted exponentially and the weighted likelihoods are normalized by the total acoustic probability.

However, prior to generating the probability, the present system first generates template 130 to constrain a modified generalized posterior probability calculation. The calculation is performed to assess the confidence of recognition hypotheses, obtained from intermediate speech recognition results 122 by applying the template 130 against those results, at marked error locations in the recognition result 120. By using a template to sift out relevant hypotheses (paths) from the intermediate speech recognition results 122, the template constrained probability estimation can assess the confidence of a unit hypothesis, as a substring hypothesis, or a substring hypothesis that includes a wild card component, as is discussed below.

In any case, the first step in generating the N-best alternative list is for template generator 110 to generate template 130. The template 130 is generated to identify a structure of possibly matching results that can be identified in intermediate speech recognition results 122, based upon the error type and the position of the error (or the context of the error) within recognition result 120. Generating the template is indicated by block 350 in FIG. 7.

In one embodiment, the template 130 is denoted as a triple, [T;s,t]. The template T is a template pattern that includes hypothesized units and metacharacters that can support regular expression syntax. The characters [s,t] define the time interval constraint of the template. In other words, they define the time frame within recognition result 120 that corresponds to the position of the marked error. The term s is the start time in the speech signal that spawned the recognition result that corresponds to a starting point of the marked error, and t is the end time in the speech signal (that generated the recognition result 120) corresponding to the marked error. Referring again to FIG. 3, for instance, assume that the marked error is in the word “speech” found in column 304. The start time s would correspond to the time in the speech signal that generated the recognition result beginning at the first “e” in the word “speech”. The end time t corresponds to the time point in the speech signal that spawned the recognition result corresponding to the end of the second “e” in the word “speech” in recognition result 120. Also, since the letter “p” in the word “speech” has not been marked as an error, it can be assumed by the system that that particular portion of recognition result 120 is correct. Similarly, because the “c” in the word “speech” has not been marked as being in error, it can be assumed by the system that that portion of recognition result 120 is correct as well. These two correct “anchor points” which bound the portion of the speech recognition result 120 that has been marked as erroneous, as well as the marked position of the error in the speech signal, can be used as context information in helping to generate a template and identify the N-best alternatives.

In one embodiment, in a regular expression of the template, the basic template can also include metacharacters, such as a “don't care” symbol *, a blank symbol Φ, or a question mark ?. A list of some exemplary metacharacters is found below in Table 1.

TABLE 1
Metacharacters in template regular expressions.

| | |
|---|---|
| ? | Matches any single word. |
| \hat{ } | Matches the start of the sentence. |
| $ | Matches the end of the sentence. |
| φ | Matches a NULL word. |
| * | Matches any 0~n words. Usually set |
| | n to 2. For example, “A*D” |
| | matches “AD”, “ABD”, “ABCD”, |
| | etc. |
| [ ] | Matches any single word that is |
| | contained in brackets. For example, |
| | [ABC] matches word “A”, “B”, or |
| | “C”. |

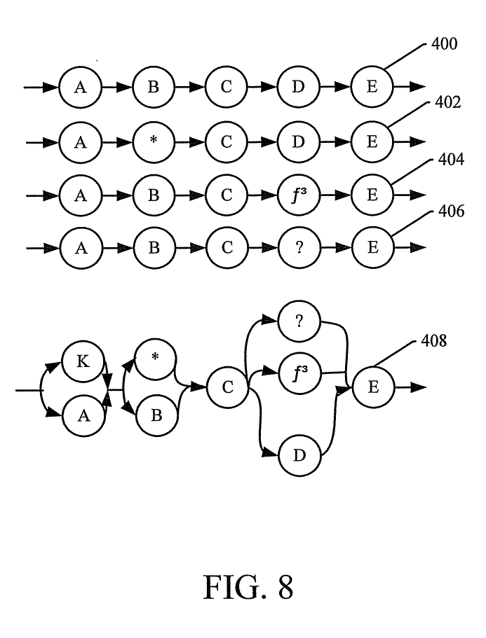

FIG. 8 shows a number of exemplary templates for the sake of discussion, illustrating the use of some metacharacterers. Of course, these are simply given by way of example and are not intended to limit the template generator, in any way.

FIG. 8 first shows a basic template 400 “ABCDE” and then shows variations of basic template 400, using some of the metacharacters shown in Table 1. The letters “ABCDE” correspond to a word sequence, each letter corresponding to a word in the word sequence. Therefore, the basic template 400 maps to intermediate search results 122 that contained all five words ABCDE in the order shown in template 400.

The next template in FIG. 8, template 402, is similar to template 400, except that in place of the word “B” an * is used. The *, as seen from Table 1, is used as a wild card symbol which matches any “0-n” words. In one embodiment, 0-n is set equal to 2, but could be any other desired number as well. For instance, template 402 would match results of the form “ACDE”, “ABCDE”, “AFGCDE”, “AHCDE”, etc. The use of the “don't care” metacharacter relaxes the matching constraints such that template 402 will match more intermediate recognition results 122 than template 400.

FIG. 8 also shows another variation of template 400, that being template 404. Template 404 is similar to template 400 except that in place of the word “D” a metacharacter “Φ” is substituted. The blank symbol “Φ” matches a null character. It indicates a word deletion at the specified position.

Template 406 in FIG. 8 is similar to template 400, except that in place of the word “D” it includes a metacharacter “?”. The ? denotes an unknown word in the specified position, and it is used to discover unknown words at that position. It is different from the “*” in that it matches only a single word rather than 0-n words in the intermediate search results 122. Therefore, the template 406 would match intermediate results 122 such as “ABCFE”, “ABCHE”, “ABCKE”, but it would not match intermediate search results in which multiple words reside at the location of the ? in template 406.

Template 408 in FIG. 8 illustrates a compound template in which a plurality of the metacharacters discussed above are used. The first position of template 408 indicates that the template will match intermediate recognition results 122 that have a first word of either A or K. The second position shows that it will match intermediate recognition results 122 that have the next word as “B” or any combination of other words. Template 408 will match only intermediate speech recognition results 122 that have, in the third word position, the word “C”. Template 408 will match intermediate speech recognition results 122 that have, in the fourth position, the word “D”, any other single word, or the null word. Finally, template 408 will match intermediate speech recognition results 122 that have, in the fifth position, the word “E”.

Different types of customized templates 130 are illustratively generated for different types of errors. For example, let W₁ . . . W_{N} be the word sequence in a speech recognition result 120, for a spoken input. In one exemplary embodiment, the template T can be designed as follows:

$$T = \{ \begin{matrix}{W}_{i} ? … ? * {W}_{i + j + 1} , & if {W}_{i + 1} … {W}_{i + j} are substitution errors ; \\ {W}_{i} * {W}_{i + 1} , & if a deletion between {W}_{i} and {W}_{i + 1} ; \\ - , & if {W}_{i + 1} {…W}_{i + j} are insertions ;\end{matrix} \qquad Eq . 1$$

where 0≦I≦N, 1≦j≦N−i, W₀=̂ (is the sentence start), W_{N+1}=$ (is the sentence end), and the symbols of “?” and “*” are the same as defined in Table 1. Eq. 1 only includes templates for correcting substitution and deletion errors. Insertion errors can be corrected by a simple deletion, and no template is needed in order to correct such errors.

Depending on the type of error indicated by the pen-based editing marks 124 provided by the user, the particular portion of the template in Eq. 1 will be used to sift hypotheses in the intermediate speech recognition results 122 output by speech recognizer 102, in order to identify alternatives for N-best alternatives list 132. Searching the intermediate search results 122 for results that match the template 130 is indicated by block 352 in FIG. 7.

The matching hypothesis are then scored. All string hypotheses that match template [T; s,t] form the hypothesis set H([T;s,t]). The template constrained posterior probability of [T;s,t] is a generalized posterior probability summed on all string hypotheses in the hypothesis set H([T:s,t]), as follows:

$$P ( [ T ; s , t ] \vert {x}_{1}^{T} ) = \sum \text{?} \frac{{\prod }_{n = 1}^{N} {p}^{α} ( {x}_{{s}_{n}}^{{t}_{n}} \vert {w}_{n} ) \cdot {p}^{S} ( {w}_{n} \vert {w}_{1}^{N} )}{p ( {x}_{1}^{T} )} \\ \text{?} \text{indicates text missing or illegible when filed} \qquad Eq . 2$$

where x₁^{T} is the whole sequence of acoustic observations, and α and β are exponential weights for the acoustic and language models, respectively.

It can thus be seen that the numerator of the summation in Eq. 2 contains two terms. The first is the acoustic model probability associated with the sequence of acoustic observations delimited by the template's starting and ending positions given a current word, and the second term is the language model likelihood for a given word, given its history. For a given hypothesis that matches the template 130 (i.e., for a given hypothesis in the hypothesis set) all of the aforementioned probabilities are summed and normalized by the acoustic probability for the sequence of acoustic observations in the denominator of Eq. 2. This score is used to rank the N-best alternatives to generate list 132.

It can thus be seen that the template 130 acts to sift the hypotheses in intermediate speech recognition results 122. Therefore, the constraints on the template can be set more fine (by generating a more restrictive template) to sift out more of the hypotheses, or can be set more coarse (by generating a less restrictive template), to include more of the hypotheses. As discussed above, FIG. 8 illustrates a plurality of different templates, that have different coarseness, in sifting the hypotheses. The language model score and acoustic model score generated by speech recognizer 102, in generating the intermediate speech recognition results 122, are used to compute how likely any of the given matching hypotheses is to correct the error marked in recognition result 120. Once all the posterior probabilities are calculated, for each matching hypothesis, then the N-best list 132 can be computed, simply by ranking the hypotheses, according to their posterior probabilities.

In calculating the template constrained posterior probabilities set out in Eq. 2, the reduced search space (the granularity of the template), the time relaxation registration (how wide the time parameters s and t are set), and the weights assigned to the acoustic and language model likelihoods, can be set according to conventional techniques used in generating generalized word posterior probability for measuring reliability of recognized words, except that in the template constrained posterior probability, the string hypothesis selection, which corresponds to the term under the sigma summation in Eq. 2. Of course, these items in the template constrained posterior probability calculation can be set by machine learned processes or empirically, as well. Scoring each matching result using a conditional posterior result probability is indicated by block 354 in FIG. 7.

The N most likely substring hypotheses which match the template, are found from the intermediate speech recognition results, and the scores generated for each. They are output as the N-best alternative list 132, in rank order. This is indicated by block 356 in FIG. 7.

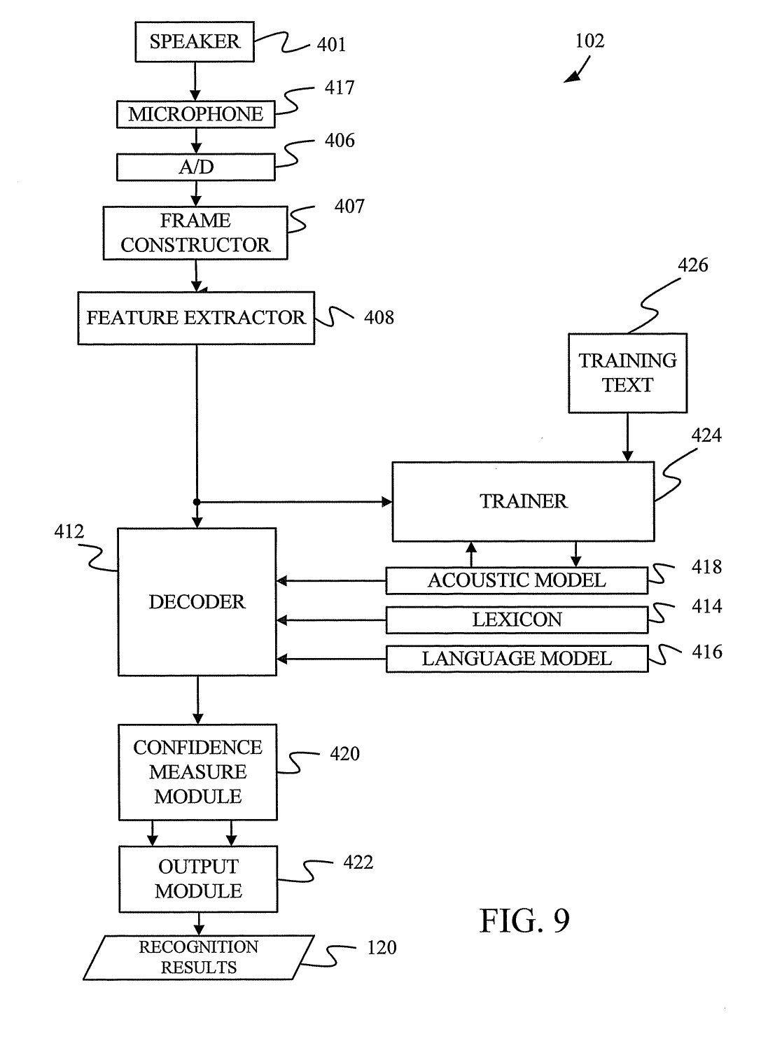

FIG. 9 shows on illustrative embodiment of a speech recognizer 102. In FIG. 9, a speaker 401 (either a trainer or a user) speaks into a microphone 417. The audio signals detected by microphone 417 are converted into electrical signals that are provided to analog-to-digital (A-to-D) converter 406.

A-to-D converter 406 converts the analog signal from microphone 417 into a series of digital values. In several embodiments, A-to-D converter 406 samples the analog signal at 16 kHz and 16 bits per sample, thereby creating 32 kilobytes of speech data per second. These digital values are provided to a frame constructor 407, which, in one embodiment, groups the values into 25 millisecond frames that start 10 milliseconds apart.

The frames of data created by frame constructor 207 are provided to feature extractor 408, which extracts a feature from each frame. Examples of feature extraction modules include modules for performing Linear Predictive Coding (LPC), LPC derived Cepstrum, Perceptive Linear Prediction (PLP), Auditory model feature extraction, and Mel-Frequency Cepstrum Coefficients (MFCC) feature extraction. Note that the invention is not limited to these feature extraction modules and that other modules may be used within the context of the present invention.

The feature extraction module produces a stream of feature vectors that are each associated with a frame of the speech signal.

Noise reduction can also be used so the output from extractor 408 is a series of “clean” feature vectors. If the input signal is a training signal, this series of “clean” feature vectors is provided to a trainer 424, which uses the “clean” feature vectors and a training text 426 to train an acoustic model 418 or other models as described in greater detail below.

If the input signal is a test signal, the “clean” feature vectors are provided to a decoder 412, which identifies a most likely sequence of words based on the stream of feature vectors, a lexicon 414, a language model 416, and the acoustic model 418. The particular method used for decoding is not important to the present invention and any of several known methods for decoding may be used. However, in performing the decoding, decoder 412 generates intermediate recognition results 122 discussed above.

Optional confidence measure module 420 can assign a confidence score to the recognition results and provide them to output module 422. Output module 422 can thus output recognition results 120, either by itself, or along with its confidence score.

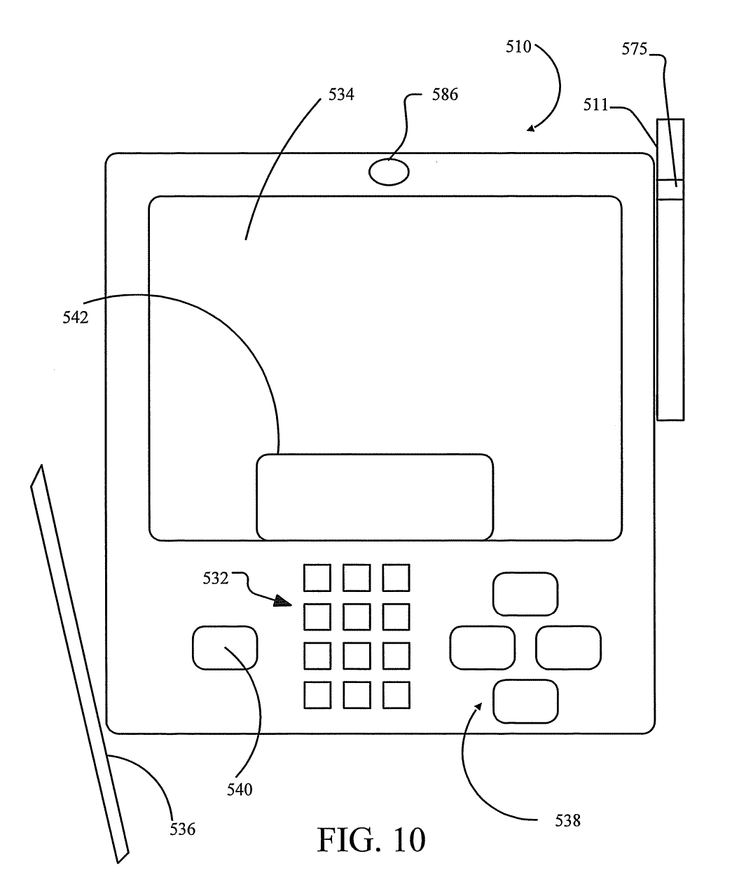

FIG. 10 is a simplified pictorial illustration of the mobile device 510 in accordance with another embodiment. The mobile device 510, as illustrated in FIG. 10, includes microphone 575 (which may be microphone 517 in FIG. 9) positioned on antenna 511 and speaker 586 positioned on the housing of the device. Of course, microphone 575 and speaker 586 could be positioned other places as well. Also, mobile device 510 includes touch sensitive display 534 which can be used, in conjunction with the stylus 536, to accomplish certain user input functions. It should be noted that the display 534 for the mobile devices shown in FIG. 10 can be much smaller than a conventional display used with a desktop computer. For example, the displays 534 shown in FIG. 10 may be defined by a matrix of only 240×320 coordinates, or 160×160 coordinates, or any other suitable size.

The mobile device 510 shown in FIG. 10 also includes a number of user input keys or buttons (such as scroll buttons 538 and/or keyboard 532) which allow the user to enter data or to scroll through menu options or other display options which are displayed on display 534, without contacting the display 534. In addition, the mobile device 510 shown in FIG. 10 also includes a power button 540 which can be used to turn on and off the general power to the mobile device 510.

It should also be noted that in the embodiment illustrated in FIG. 10, the mobile device 510 can include a hand writing area 542. Hand writing area 542 can be used in conjunction with the stylus 536 such that the user can write messages which are stored in memory for later use by the mobile device 510. In one embodiment, the hand written messages are simply stored in hand written form and can be recalled by the user and displayed on the display 534 such that the user can review the hand written messages entered into the mobile device 510. In another embodiment, the mobile device 510 is provided with a character recognition module (or handwriting recognition component 116) such that the user can enter alpha-numeric information (such as handwriting input 140), or the pen-based editing marks 124, into the mobile device 510 by writing that information on the area 542 with the stylus 536. In that instance, the character recognition module in the mobile device 10 recognizes the alpha-numeric characters, pen-based editing marks 124, or other symbols and converts the characters into computer recognizable information which can be used by the application programs or the error identification component 108, or other components in the mobile device 510.

Although the subject matter has been described in language specific to structural features and/or methodology acts, it is to be understood that the subject matter defined in the appended claims is not necessarily limited to the specific features or acts described above. Rather, the specific features and acts described above are disclosed as example forms of implementing the claims.

What is claimed is:

1. A method of correcting speech recognition result output by a speech recognizer, comprising:
displaying the speech recognition result as a sequence of tokens on a user interface display;
receiving editing marks on the displayed speech recognition result, input by a user, through the user interface display;
identifying an error type and error position within the speech recognition result based on the editing marks; and
replacing tokens in the speech recognition result, marked by the editing marks as being incorrect, with alternative tokens, based on the error type and error position identified, to obtain a revised speech recognition result; and
outputting the revised speech recognition result for display on the user interface display.

2. The method of claim 1 wherein identifying an error type and error position comprises:
performing handwriting recognition on symbols in the editing marks to identify a type of error represented by the symbols; and
identifying a position in the speech recognition result that the editing marks occur to identify the error position.

3. The method of claim 2 and further comprising:
prior to replacing tokens, generating a list of alternative tokens based on the error type and error position.

4. The method of claim 3 wherein generating a list of alternative tokens, comprises:
generating a template indicative of a structure of alternative speech recognition results that are hypothesis error corrections for the speech recognition result.

5. The method of claim 4 wherein the speech recognizer generates a plurality of intermediate recognition results prior to outputting the speech recognition result, and wherein generating a list of alternative tokens further comprises:
comparing the template against the intermediate recognition results, generated for a position in the speech recognition result that corresponds to the error position, to identify as the list of alternative tokens, a list of intermediate recognition results that match the template.

6. The method of claim 5 and further comprising:
generating a posterior probability confidence measure for each of the intermediate recognition results; and
ranking the list of intermediate recognition results in order of the confidence measure.

7. The method of claim 6 wherein the speech recognizer generates language model scores and acoustic model scores for each of the intermediate recognition results and wherein generating the posterior probability confidence measure comprises:
generating the posterior probability confidence measure based on the acoustic model scores and language model scores for each of the intermediate recognition results.

8. The method of claim 6 wherein replacing tokens comprises:
automatically replacing the tokens in the speech recognition result with a top ranked intermediate recognition result from the ranked list of intermediate recognition results.

9. The method of claim 8 and further comprising:
displaying, as the revised speech recognition result, the speech recognition result with tokens replaced by the top ranked intermediate recognition result;
displaying the ranked list of intermediate recognition results;
if the revised speech recognition result is incorrect, receiving a user selection, through the user interface display, of a correct one of the intermediate recognition results in the ranked list; and
displaying the speech recognition result as the correct one of the intermediate recognition results.

10. The method of claim 9 and further comprising:
if none of the intermediate recognition results in the ranked list is correct, receiving a user handwriting input of the correct speech recognition result;
performing handwriting recognition on the user handwriting input to obtain a handwriting recognition result; and
displaying as the revised speech recognition result, the handwriting recognition result.

11. A user interface system used for performing correction of speech recognition results generated by a speech recognizer, comprising:
a user interface display displaying a speech recognition result;
a user interface component configured to receive through the user interface display, handwritten editing marks on the speech recognition result and being indicative of an error type of an error located at an error position in the speech recognition result where the handwritten editing mark is made;
a template generator generating a template indicative of alternative speech recognition results based on the error type and error position;
an N-best alternative generator configured to identify intermediate speech recognition results output by the speech recognizer that match the template and to score each matching intermediate speech recognition result to obtain an N-best list of alternatives comprising the N-best scoring intermediate speech recognition results that match the template; and
an error correction component configured to generate a revised speech recognition result by revising the speech recognition result with one of the N-best alternatives and to display the revised speech recognition result on the user interface display.

12. The user interface system of claim 11 and further comprising:
a handwriting recognition component configured to identify the error type based on symbols in the handwritten editing marks.

13. The user interface system of claim 11 wherein the error correction component is configured to automatically generate the revised speech recognition result using a top ranked one of the N-best alternatives.

14. The user interface system of claim 12 wherein the error correction component is configured to generate the revised speech recognition result using a user selected one of the N-best alternatives.

15. The user interface system of claim 12 wherein the handwriting recognition component receives a handwriting input indicative of a handwritten correction of the displayed speech recognition result and generates a handwriting recognition result based on the handwritten correction, and wherein the error correction component is configured to generate the revised speech recognition result using the handwriting recognition result.

16. A method of correcting a speech recognition result displayed on a touch sensitive user interface display, comprising:
receiving a handwritten input identifying an error type and error position of an error in the speech recognition result, through the touch sensitive user interface display;
generating a list of alternatives for the speech recognition result at the error position; and
performing error correction by:
automatically generating a revised speech recognition result using a first alternative in the list and displaying the revised speech recognition result;
displaying the list of alternatives, and, if the revised speech recognition result is incorrect, receiving a user selection of a correct one of the alternatives and displaying the revised speech recognition result using the selected correct alternative, and
if a user input is received indicative of there being no correct alternative in the list, receiving a user handwriting input indicative of a user written correction of the error, performing handwriting recognition on the user handwriting input to generate a handwriting recognition result and displaying the revised speech recognition result using the handwriting recognition result.

17. The method of claim 16 wherein generating a list of alternatives comprises:
generating an alternative template identifying a structure of alternative results used to correct the speech recognition result; and
matching the template against intermediate speech recognition results output by a speech recognition system to identify a list of matching alternatives;
calculating a posterior probability score for each of the matching alternatives; and
ranking the matching alternatives based on the score to obtain a ranked list of a top N scoring alternatives.

18. The method of claim 16 and further comprising:
performing handwriting recognition on the handwritten input to identify the error type and error position.

19. The method of claim 18 wherein the user interface display comprises a touch sensitive screen, and wherein the handwritten input comprises pen-based editing inputs on the speech recognition result displayed on the touch sensitive screen.

20. The method of claim 17 wherein calculating comprises:
calculating the posterior probability score using language model scores and acoustic model scores generated for the intermediate speech recognition results by the speech recognition system.
